(19) United States
(12) Patent Application Publication
(10) Pub. No.: US 2001/0044818 A1
(43) Pub. Date: Nov. 22, 2001

(54) System and method for identifying and blocking pornogarphic and other web content on the internet

(76) Inventor: Yufeng Liang, Matawan, NJ (US)

Correspondence Address: PENNIE AND EDMONDS, 1155 AVENUE OF THE AMERICAS, NEW YORK, NY, 100362711

(21) Appl. No.: 09/788,814

(22) Filed: Feb. 20, 2001

Related U.S. Application Data
(60) Provisional application No. 60/183,727, filed on Feb. 21, 2000.
(60) Provisional application No. 60/183,728, filed on Feb. 21, 2000.

(51) Int. Cl. G06F 15/16

(52) U.S. Cl. 709/201

(57) ABSTRACT

A system and method are disclosed for identifying and blocking unacceptable web content, including pornographic web content. In a preferred embodiment, the system comprises a proxy server connected between a client and the Internet that checks a requested URL against a block list that may include URLs identified by a web spider. If the URL is not on the block list, the proxy server requests the web content. When the web content is received, the proxy server processes its text content and compares the processing results using a thresholder. If necessary, the proxy server then processes the image content of the retrieved web content to determine if it comprises skin tones and textures. Based on these processing results, the proxy server may either block the retrieved web content or permit user access to it. Also disclosed is a system and method for inserting advertisements into retrieved web content.

This application claims priority to U.S. Provisional Application No. 60/183, 727 and U.S. Provisional Application No. 60/183,728, each of which is hereby incorporated by reference.

### BACKGROUND OF THE INVENTION

Tools for identifying and blocking pornographic websites on the Internet are known in the art. Typically, these tools comprise a “block” list comprising URLs of known pornographic sites. When an unauthorized user attempts to retrieve web content from a site on the block list, the user's browser blocks the request.

It is difficult, however, to keep the block list current because objectionable web sites are constantly being added to the Internet. Moreover, these prior art tools fail to block sites that are not on the block list.

### SUMMARY OF THE INVENTION

A system and method are disclosed for identifying and blocking unacceptable web content, including pornographic web content. In a preferred embodiment, the system comprises a proxy server connected between a client and the Internet that processes requests for web content. The proxy server checks the requested URL against a block list that may include URLs identified by a web spider. If the URL is not on the block list, the proxy server requests the web content.

When the web content is received, the proxy server processes its text content and compares the processing results using a thresholder. If necessary, the proxy server then processes the image content of the retrieved web content to determine if it comprises skin tones and textures. Based on these processing results, the proxy server may either block the retrieved web content or permit user access to it.

Also disclosed is a system and method for inserting advertisements into retrieved web content. In a preferred embodiment, the system inserts html content that may comprise a hyperlink into the top portion of the retrieved web content.

### BRIEF DESCRIPTION OF THE DRAWINGS

The above summary of the invention will be better understood when taken in conjunction with the following detailed description and accompanying drawings, in which:

FIG. 1 is a block diagram of a first preferred embodiment of the present system;

FIG. 2 is a block diagram of a second preferred embodiment of the present system;

FIG. 3 is a flow diagram depicting a preferred process implemented by the embodiments shown in FIGS. 1 and 2;

FIG. 4A is a flow diagram depicting a preferred embodiment of a text analysis algorithm employed by the present system;

FIG. 4B is a preferred embodiment of a lexicon of words and values assigned to them employed by the present system;

FIG. 5 is a block diagram of a preferred text analysis engine of the present system;

FIG. 6 is a flow diagram depicting a preferred embodiment of an algorithm for determining the h values used by the text analysis engine of FIG. 5;

FIG. 7 is a block diagram of a preferred image analysis engine of the present system;

FIG. 8A is a flow diagram depicting a preferred filtering algorithm for use in the present system;

FIG. 8B depicts an image area to be filtered using the filtering algorithm depicted in FIG. 8A;

FIG. 9 is a flow chart depicting a preferred algorithm employed by a web spider to create a list of unacceptable web sites; and

FIG. 10 is a flow chart depicting a preferred algorithm for inserting advertisements into retrieved web content.

### DETAILED DESCRIPTION OF THE PREFERRED EMBODIMENTS

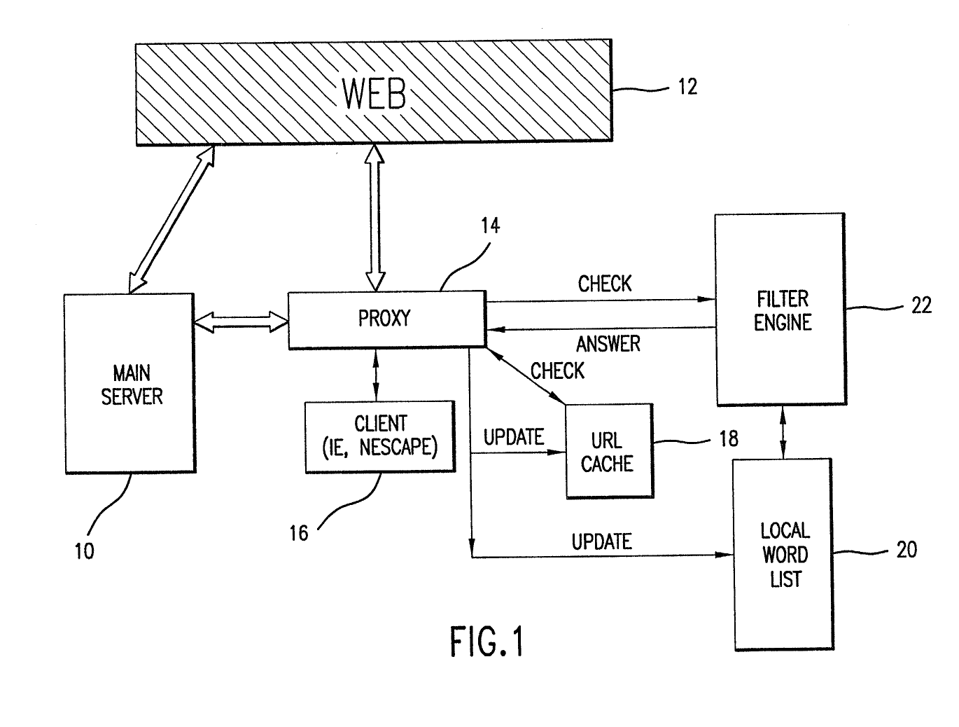

FIG. 1 is a block diagram of a first preferred embodiment of the present system. As shown in FIG. 1, the system preferably comprises a proxy server 14 that is designed to receive URL requests for web content from a client 16. Typically, client 16 will be one of many clients connected to a network (not shown). Each request for web content by a client 16 that is transmitted over the network is forwarded to proxy server 14 for processing.

Proxy server 14 determines whether the request is permissible (as described in more detail below) and, if it is, forwards the request to an appropriate web site (not shown) via world-wide-web 12. When a web page or other content is received from the web site, proxy server 14 determines whether the content is acceptable, and, if it is, forwards the web page to client 16.

In a preferred embodiment, a URL is deemed acceptable if it does not identify a pornographic web site. Similarly, a web page or other web content is acceptable if it does not comprise pornographic content.

As further shown in FIG. 1, the system also preferably comprises a URL cache 18 that stores a list of impermissible URLs. In addition, the system preferably comprises a local word list 20 and a filter engine 22 which are used by proxy server 14 to identify pornographic material, as described in more detail below.

In a preferred embodiment, URL cache 18 may be populated in several ways. First, cache 18 may be populated with a list of known pornographic websites. Second, an authorized user may specify specific URLs that are unacceptable. Third, an authorized user may specify specific URLs that are acceptable (i.e., that should not be blocked, even though the remaining components of the system, described below, would identify the content as pornographic). Fourth, URL cache 18 may be populated by a web spider. A preferred embodiment of a particular web spider for use with the present system is described in more detail below.

In a preferred embodiment, when a site is designated acceptable even though it comprises pornographic material, access to that site is limited to authorized individuals, such as, for example, the individual that designated the site acceptable. In this way, for example, an adult may designate certain sites acceptable and nevertheless block access to such sites by a child.

Also shown in FIG. 1 is a main server 10. Main server 10 serves several functions including maintaining an updated list of unacceptable URLs, as described in more detail below. Typically, main server 10 is not co-located with proxy server 14 or client 16. Rather, it is typically located in a remote location from where it may provide updated unacceptable URL lists and other services to a plurality of proxy servers 14 and clients 16.

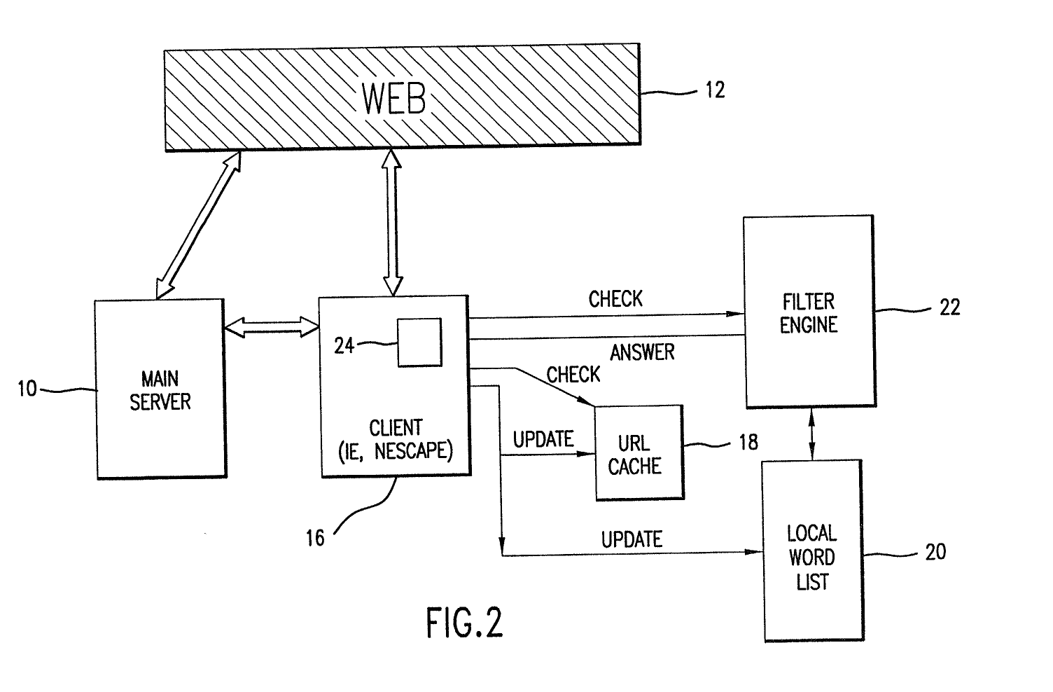

FIG. 2 is an alternative preferred embodiment of the present system. As shown in FIG. 2, in this alternative embodiment, a client 16 may be connected directly to the Internet. In that event, URL cache 18, local word list 20, filter engine 22, as well as software 24 for using these modules is preferably resident in client 16.

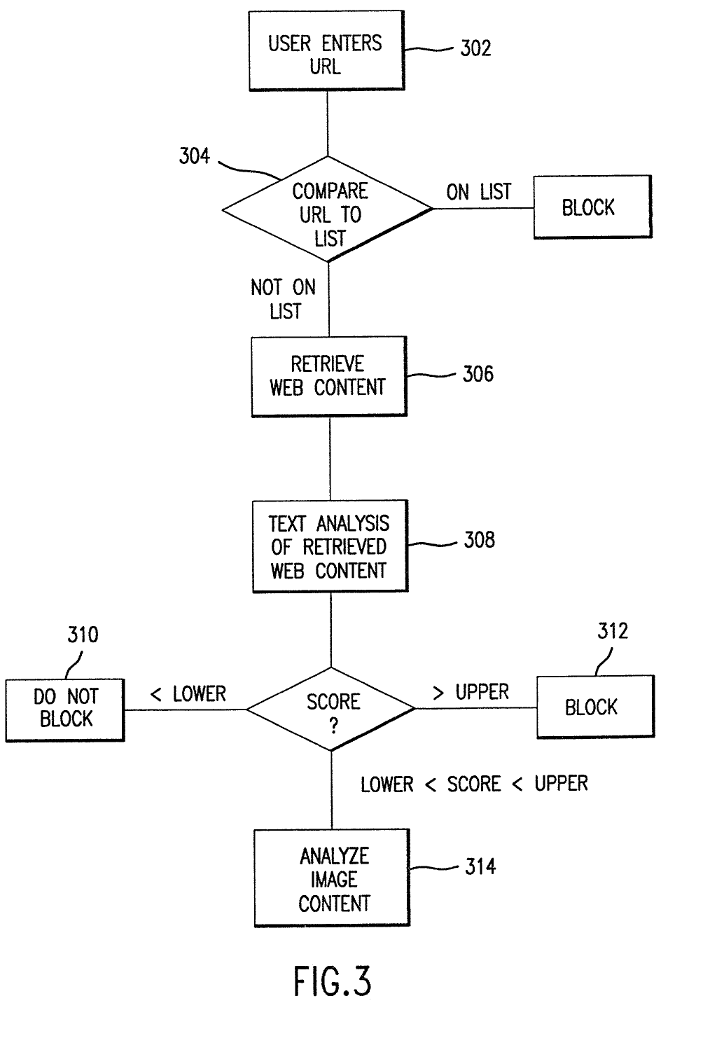

FIG. 3 is a flow diagram depicting a preferred process implemented by the embodiments shown in FIGS. 1 and 2. For purposes of ease of description, the following description will refer primarily to the architecture disclosed in FIG. 1. It will be understood, however, that the same steps may be performed by corresponding components shown in FIG. 2. In addition,it should be noted that although the steps in FIG. 3 are demonstrated as sequential, the text and image analysis engines described below may instead be designed to operate in parallel. In particular, parallel operation may be desirable when large processing resources are available, while the serial approach described below may be preferable when there is a desire to conserve processing resources.

Turning to FIG. 3, in step 302, a user enters a URL onto the command line of his or her browser. In step 304, server 14 compares the URL to the list of unacceptable URLs stored in URL cache 18. If the URL is on the list, then server 14 blocks the user's request, and does not obtain the requested web page specified by the URL.

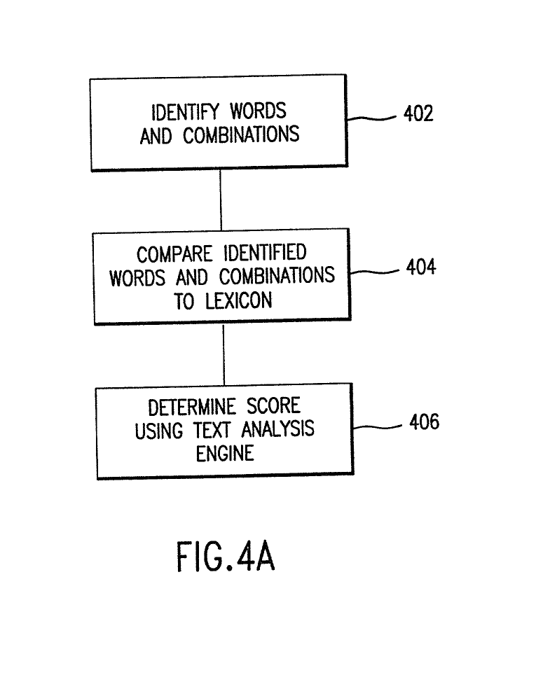

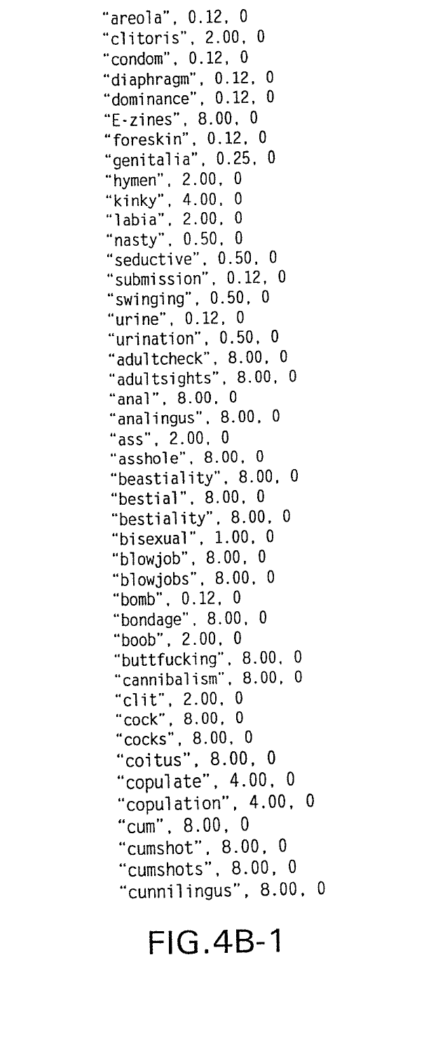

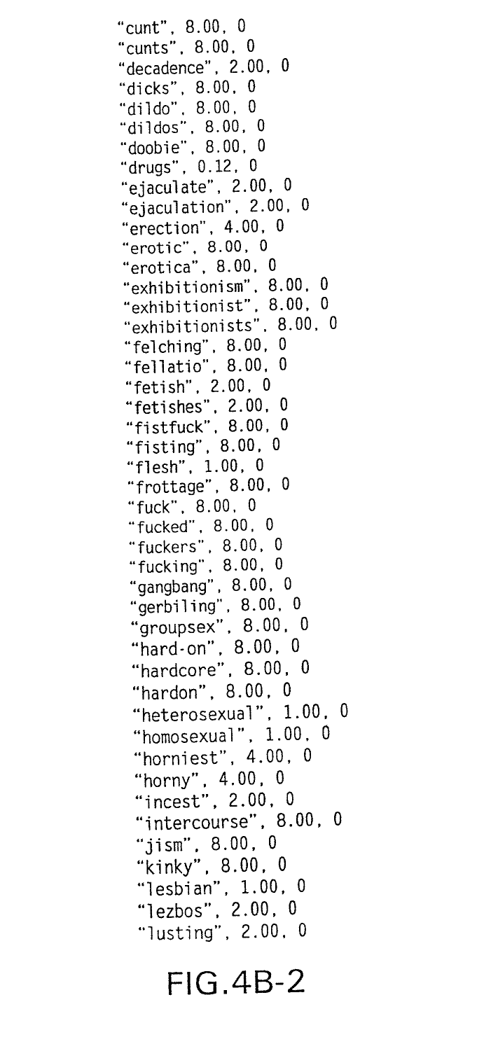

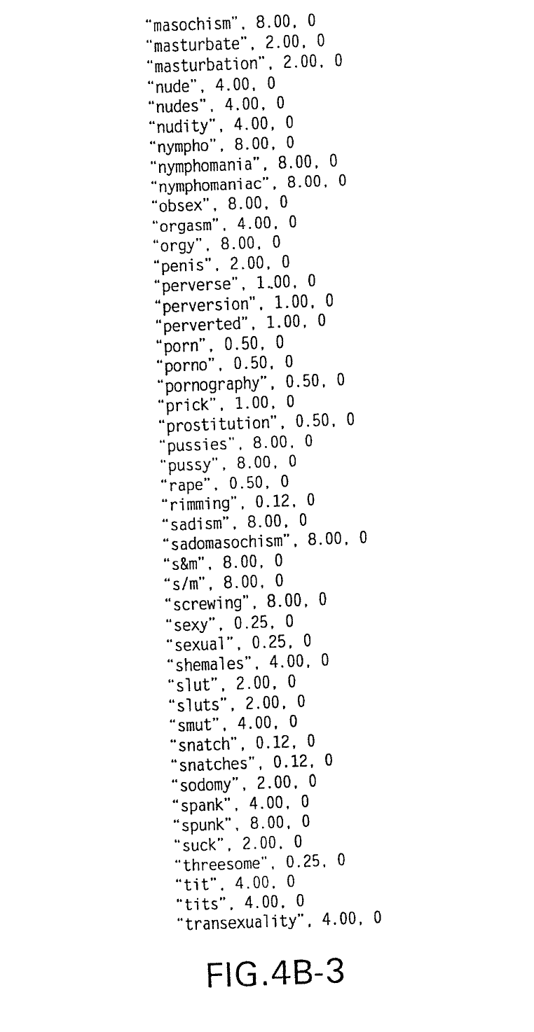

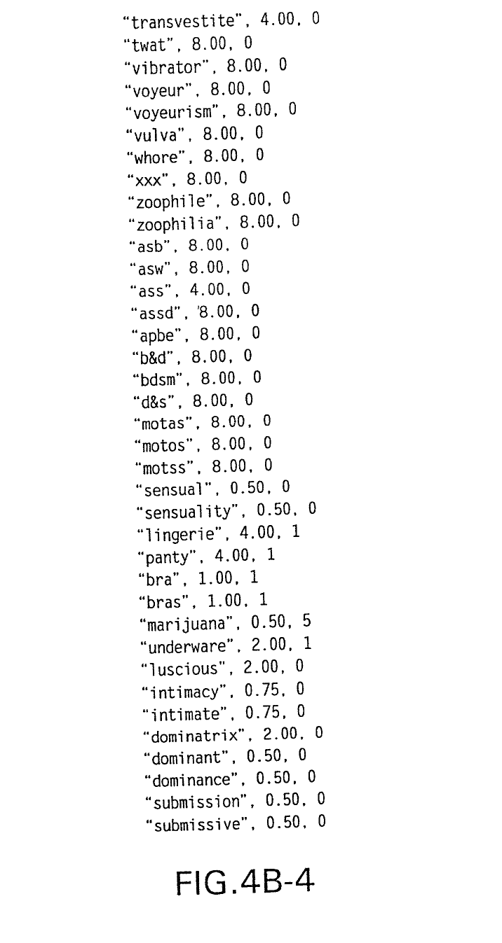

Otherwise, if the URL is acceptable, server 14 transmits a URL request via web 12 to retrieve the requested web page (step 306). When the web page is returned, server 14 conducts a text analysis of the text content of the web page (step 308). A preferred embodiment of this text analysis is described in connection with FIGS. 4-6.

As shown in FIG. 4A, in step 402, server 14 first analyzes the text content of the retrieved web page and identifies every word or combination of words that it contains. It should be noted that this text search preferably includes not only text that is intended to be displayed to the user, but also html meta-text such as hyperlinks. It should also be noted that the identified words may include a substring within a longer word in the text.

In step 404, server 14 compares each word and combination of words to a lexicon of words stored in local word list 20. A preferred embodiment of lexicon 20 is shown in FIG. 4B.

It should be noted that each of the words in the lexicon shown in FIG. 4B has two values following it, and that those words associated with the preferred embodiment being discussed presently are those that have a “0” as their second value. These words are associated with pornography and are utilized by the system to identify pornographic material, as described below. Words having a value other than “0” as their second value are preferably associated with other concepts or categories of material, as described in more detail below.

As further shown in FIG. 4B, each word or combination of words in local word list 20 is also assigned a first value. In the preferred embodiment shown in FIG. 4B, this first value is between 0.25 and 8. If a word or combination of words found in the web content is in the lexicon, server 14 retrieves this assigned value for the word or combination of words.

In step 406, server 14 uses the retrieved values as inputs to a text analysis engine for determining a score that is indicative of the likelihood that the retrieved web content is pornographic. In a preferred embodiment, the text analysis engine employs artificial intelligence to determine the likelihood that the retrieved web content is pornographic. A block diagram of a preferred text analysis engine is described in connection with FIG. 5.

As shown in FIG. 5, text analysis engine 502 preferably comprises a plurality of inputs x₁, x₂, . . . xₙ, which are provided to multipliers 504. Each x₁ represents the value retrieved from local word list 20 for the i^{th} word or combination of words found in the text of the retrieved web content. It should be noted that if a word in the lexicon appears n times in the text, the system preferably multiplies the retrieved value assigned to the word by n and supplies this product as input x₁ to text analysis engine 502.

Each multiplier 504 multiplies one input x₁ by a predetermined factor h₁. A preferred method for determining factors h₁, h₂, . . . , hₙ is described below.

The outputs of multipliers 504 are then added an adder 506. The output of adder 506 is then provided to a thresholder 508 that implements a sigmoid function. The output of thresholder 508 therefore may be: 1 ) less than a lower threshold; 2 ) between a lower threshold and an upper threshold; or 3) above the upper threshold. In a preferred embodiment, the lower threshold may be approximately 0.25 and the upper threshold may be approximately 0.5.

Returning to step 308 of FIG. 3, if the output of thresholder 508 is below the lower threshold, then server 14 concludes that the retrieved web content is not pornographic, and server 14 forwards the retrieved web content to client 16 (step 310). If the output of thresholder 508 is above the upper threshold, then server 14 concludes that the retrieved web content is pornographic, and server 14 “blocks” the content by not sending it to client 16 (step 312).

If, however, the output of thresholder 508 is above the lower threshold but below the upper threshold, then the system proceeds to step 314, where it analyzes the image content of the retrieved web content to determine whether the retrieved web content is pornographic.

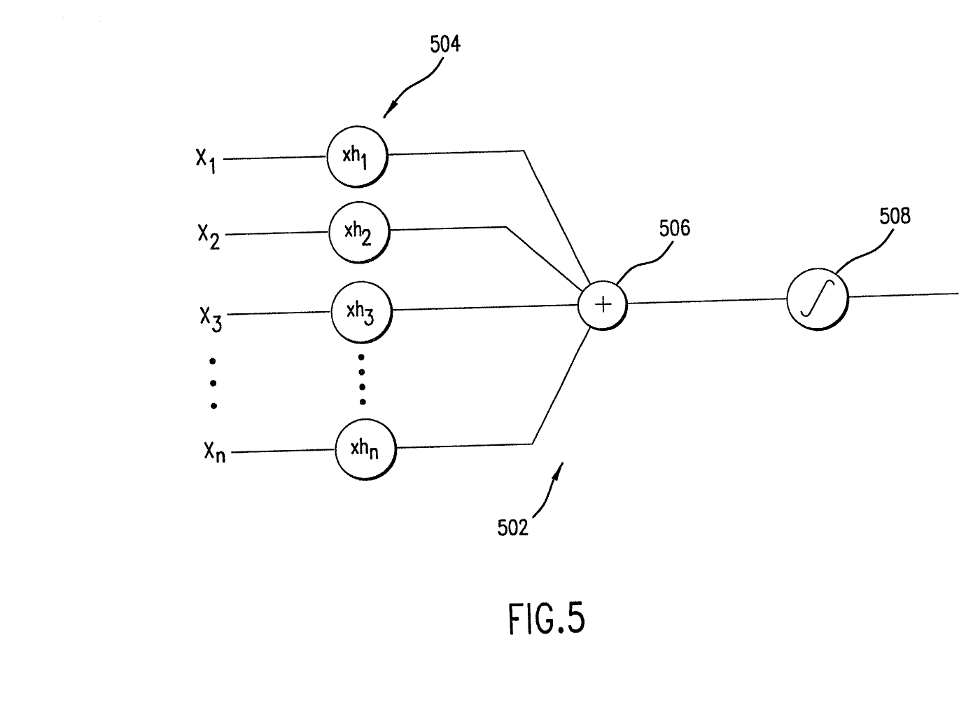

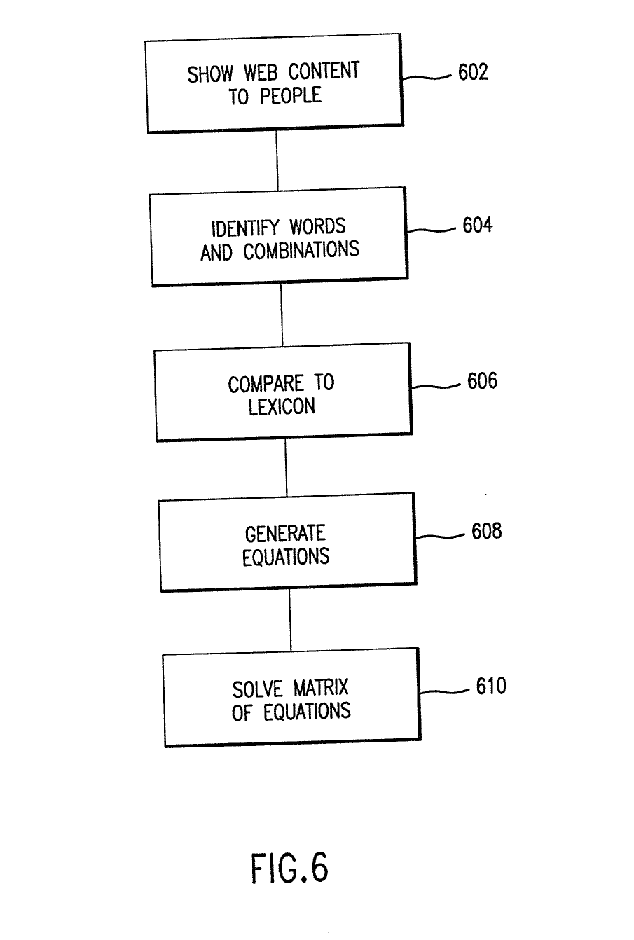

Before turning to step 314, however, a preferred embodiment for determining the h values used by the text analysis engine is first described in connection with FIG. 6. The steps in this preferred embodiment may, for example, be performed by main server 10.

As shown in FIG. 6, in step 602 a plurality of web sites are shown to a plurality of people. With respect to each web site, each person states whether they consider the site's content to be pornographic or not. In step 604, the text content of each web page categorized by the plurality of people is analyzed to identify every word and combination of words that it contains. In step 606, each word and combination of words is compared to a lexicon of words, typically the same as the lexicon stored in local word list 20. If a word or combination of words found in the web content is in the lexicon, the assigned value for the word or combination of words is retrieved.

In step 608, the system generates an equation for each person's opinion as to each web site. Specifically, the system generates the following set of equations:

(x₁⁽¹⁾*h₁)+(x₂⁽¹⁾+h₂)+. . . (xₙ⁽¹⁾*hₙ)=y₁

(x₁⁽²⁾*h₁)+(x₂⁽²⁾+h₂)+. . . (xₙ⁽²⁾*hₙ)=y₂

(x₁^{(A)}*h₁)+(x₂^{(A)}+h₂)+. . . (xₙ^{(A)}*hₙ)=y_{A}

OR:

[X]*[H]=[Y]

where:

xᵢ is the value retrieved from the database for the i^{th} word or combination of words found in the text of the web site that is also in the lexicon,

hᵢ is the multiplier to be calculated for the i^{th} word or combination of words found in the text of the web site that is also in the lexicon, and

yᵢ is either 0 or 1 depending on whether the j^{th} person stated that he or she found the web site to be pornographic or not (0=not pornographic).

In step 610, the system solves this matrix of equations as:

[H]=[X]⁻¹[Y]

It should be noted that when [X] does not have an inverse, a least square algorithm may instead be used as an approximation for the value of [X]⁻¹. It should also be noted that if the x values are chosen wisely, then one may expect the h values to fall between 0.9 and 1.1.

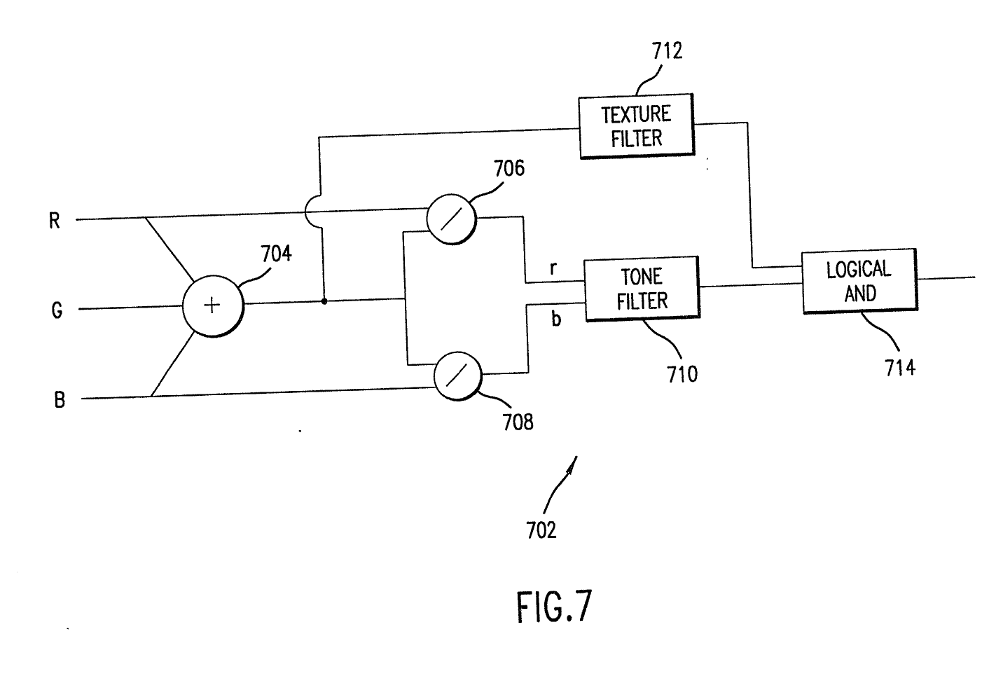

Returning to FIG. 3, recall that when the text analysis fails to conclusively demonstrate whether the retrieved web content is or is not pornographic, the system proceeds to step 314 where an image analysis of the retrieved web content is performed. A preferred embodiment for performing this image analysis is described in connection with FIG. 7.

FIG. 7 is a block diagram of a preferred image analysis engine of the present system. As shown in FIG. 7, an image analysis engine 702 preferably comprises an adder 704 that receives the luminescence values for the red, green, and blue components of each pixel in the image and adds them to determine brightness (L=R+G+B). A first divider 706 divides this sum by the pixel's red value to determine the normalized red value r, where r=R/(R+G+B). Similarly, a second divider 708 divides the brightness by the pixel's blue value to determine the normalized blue value b, where b=B/(R+G+B). Together, these two values, r and b, define the image tone for each pixel.

Values r and b are supplied to a tone filter 710. Interestingly, it has been found that although images of human skin appear markedly different to viewers (e.g., white, black, yellow, brown, etc.), this difference is a function of the image brightness rather than the tone. In fact, it has been found that the distribution of pixels representing skin in an image is relatively constant and follows a Gaussian distribution. Therefore, if the normalized red and blue values of all the pixels in an image are plotted on a graph of r vs. b, approximately 95% of pixels in the image that represent skin will fall within three standard deviations of the intersection of the mean values of r and b for pixels representing skin. Tone filter 710 identifies pixels having r and b values within three standard deviations of the mean values of r and b and thus identifies portions of the image that are likely to include skin.

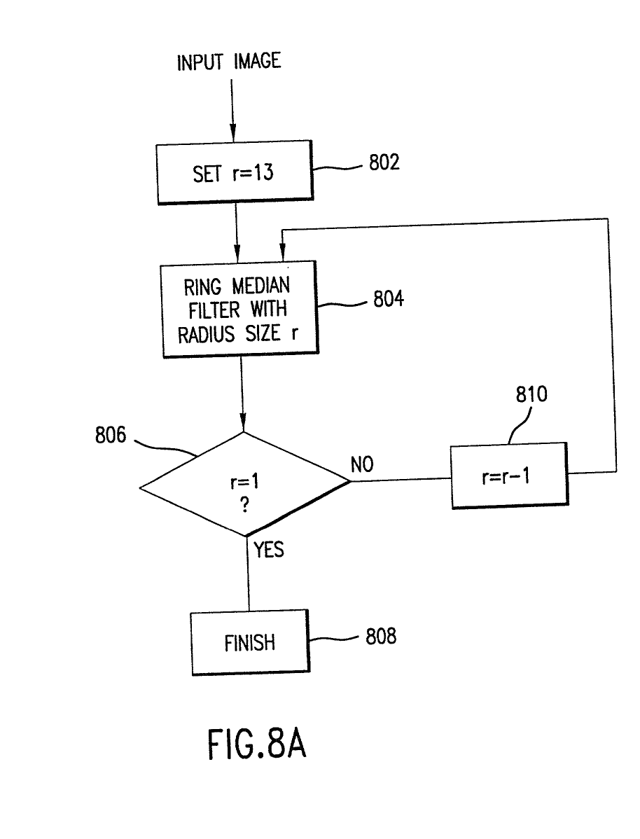

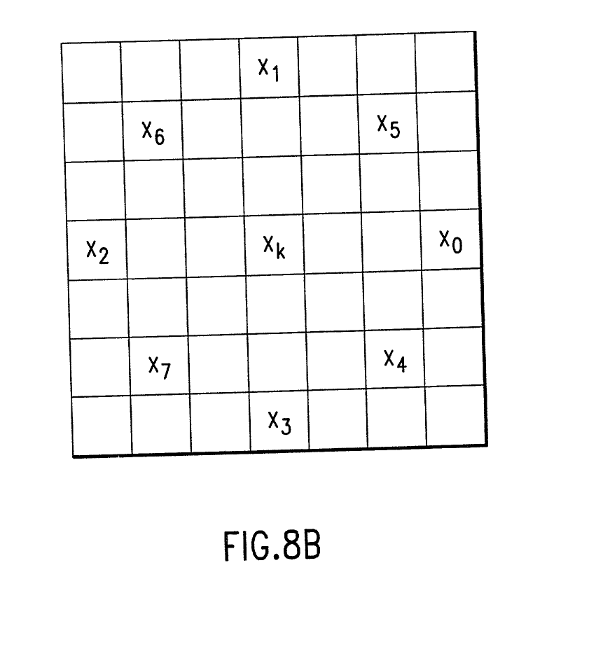

Interestingly, it has been found that areas in an image representing skin typically have relatively low granularity. As a consequence, such areas of the image have little energy in the high spatial frequency. Areas of the image that include skin can therefore be distinguished by a high-pass spatial filter. A preferred embodiment for a texture filter 712 incorporating such a high-pass spatial filter is described in connection with FIGS. 8A-B.

Texture filter 712 preferably employs multi-resolution median ring filtering to capture multi-resolution textural structure in the image being considered. A median filter may essentially be considered as a band-pass filter. Median filters are non-linear and, in most cases, are more robust against spiky image noise. Such filters capture edge pixels in multiple resolutions using a recursive algorithm, depicted in FIG. 8A.

As shown in FIG. 8A, in step 802, the filter is set to a first ring radius r. In a preferred embodiment, r may be initially set to 13. In step 804, the image is filtered by replacing each pixel xₖ in the image with the median of the values of eight pixels lying on a circle at radius r from pixel xₖ, as shown in FIG. 8B for the example of r=3. Thus, each pixel xₖ is replaced by: median(x₀, x₁, x₂, . . . , x₇). This process is equivalent to conducting a non-linear band-pass filtering of the image.

In step 806, it is determined whether r=1. If it is, then the process finishes at step 808. Otherwise, r is set to r−1 (step 810 ), and the process loops back to step 804 to again filter the image. Thus, filtering is recursively conducted until r is equal to 1.

The resulting image is a smoothed version of the original image at various resolutions.

Texture filter 712 then abstracts this resulting image from the original image to obtain the texture image.

Once the texture image is obtained, a local 5×5 average “I” of the image is obtained for each pixel (i,j) and that average is compared to a threshold. If I(i,j)>threshold, then (i,j) is considered to be a textural pixel, and thus does not represent a skin area. Otherwise, if I(i,j)<threshold, then (i,j) is considered not a textural pixel.

The outputs of tone filter 710 and texture filter 712 are ANDed together by logical AND 714. If tone filter 710 identifies a pixel as having a skin tone and texture filter 712 identifies a pixel as being a not textural pixel, then the output of logical AND 714 indicates that the pixel represents a skin area.

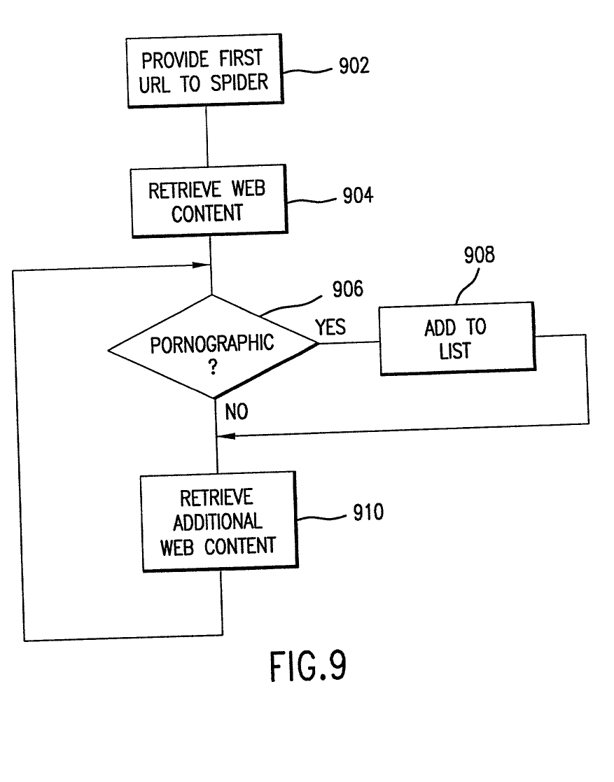

As noted above, in a preferred embodiment, URL cache 18 may be populated by a web spider 26. Web spider 26 may preferably be co-located with main server 10, and may periodically download to server 14 an updated list 28 of ULRLs of pornographic web sites that it has compiled. Web spider 26 is preferably provided with a copy of the lexicon described above as well the text analysis engine and image analysis engine described above so as to permit it to recognize pornographic material. A preferred embodiment of a particular web spider for use with the present system is now described in connection with FIG. 9.

As shown in FIG. 9, in step 902, web spider 26 is provided with a first URL of a web site known to contain pornographic material. In a preferred embodiment, the web site is one that comprises a plurality of links to both additional pages at the pornographic website, as well as other pornographic websites.

In step 904, web spider 26 retrieves the web page associated with the first URL. In step 906, web spider 26 determines whether the retrieved web content contains pornographic material. If it does, then in step 908, web spider 26 adds the URL to list 28.

In step 910, web spider 26 then retrieves another web page having a link in the first URL that it received. The process then returns to step 906, where web spider 26 again determines whether the retrieved web page comprises pornographic material and, if it does, to step 908, where the URL of the pornographic page is added to list 28.

This loop preferably continues until web spider 26 exhausts all web pages that link, directly or indirectly, to the first URL that it was provided. At that point, an additional “seed” URL may be provided to web spider 26, and the process may continue.

In a preferred embodiment, web spider 26 employs a width-first algorithm to explore all linked web pages. Thus, for example, web spider 26 examines the web pages linked by direct links to the original URL before proceeding to drill down and examine additional pages linked to those pages that link to the original URL.

In a preferred embodiment, if any page in a website is discovered as comprising pornographic material, all pages “below” that page in the sitemap for the web site may be blocked. Pages above the pornographic page may preferably remain unblocked.

Alternatively, an entire website may be designated unacceptable if any of its web pages are unacceptable.

In a further preferred embodiment, a user may program the system to filter out additional subject matter that is not, strictly speaking, pornographic. For example, if desired, the system may identify material relating to the concepts “bikini” or “lingerie”. In the exemplary lexicon shown in FIG. 4B, for example, the words “lingerie,” “bra,” etc. are included in the lexicon and assigned a second value equal to “1” to identify them as belonging to the lingerie category. The system will then search for these terms during the text analysis and, either on the basis of text alone, or in combination with the image analysis, will identify and block web content directed to these subjects.

In addition, a user may program the system to filter out subject matter relating to other areas such as hate, cults, or violence by adding terms relating to these concepts to the lexicon.

The system will then search for these terms during the text analysis and block web content directed to these subjects. In the exemplary lexicon shown in FIG. 4B, for example, words associated with hate groups may be added to the lexicon and assigned a second value equal to 2, words associated with cults may be added to the lexicon and assigned a second value equal to 3, and words associated with violence may be added to the lexicon and assigned a second value equal to 4. In addition, other words that do not necessarily correspond to a defined category (e.g., marijuana), may be added to the lexicon and assigned a second value equal, e.g., to 5, if they are deemed likely to occur in objectionable material.

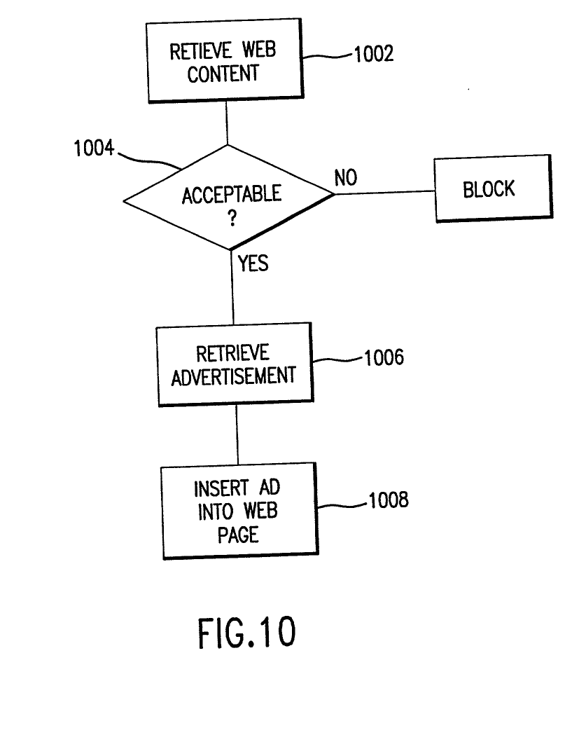

In another aspect, the present system may also comprise the capability to insert advertisements into web pages displayed to a user. This preferred embodiment is described in connection with FIG. 10. As shown in FIG. 10, in step 1002, server 14 receives a web page from web 12. In step 1004, server 14 determines whether the content of the web page is acceptable, as described in detail above.

In step 1006, server 14 retrieves from memory an advertisement for insertion into the web page. In a preferred embodiment, this advertisement may include an html link to be inserted near the top of the retrieved html web page.

In step 1008, server 14 inserts the advertisement into the retrieved web content. Thus, for example, after the ad is inserted, the retrieved web content may take the following form:

| | |
|---|---|
| <html> | |
| <head> | </head> |
| <body> | |
| <a href = “http://www._{——————}.com”>Buy Golf Equipment! | </a> |
| </body> | |
| </html> | |

In a preferred embodiment, server 14 inserts the advertisement into the top portion of the retrieved web page, even if the retrieved web page comprises several frames. This may be accomplished, for example, with a short piece of Javascript. For example:

<script.Javascript>
if (self = top | self = top.frame[0])
insert (advertisement)

While the invention has been described in conjunction with specific embodiments, it is evident that numerous alternatives, modifications, and variations will be apparent to those skilled in the art in light of the foregoing description.

1. A system for identifying possibly pornographic web sites comprising:
a feature extraction module, the feature extraction module comprising:
a first module for extracting the URL of the website from a request for web content;
a second module for extracting text from text portions of the web page;
a third module for extracting image portions from the web page that likely correspond to the skin of an individual; and
a fusion module for evaluating the output from the feature extraction module and determining whether the web page comprises possibly pornographic content.

2. The system of claim 1, further comprising a URL cache.

3. The system of claim 2, wherein the URL cache comprises a list of unacceptable URLs.

4. The system of claim 2, wherein the URL cache comprises a list of acceptable URLs.

5. The system of claim 4, wherein the acceptable URLs are accessible only by authorized individuals.

6. The system of claim 2, wherein the URL cache is populated by a web spider.

7. The system of claim 1, further comprising a list of words found in pornographic material.

8. The system of claim 7, wherein each word in the list is assigned a value.

9. The system of claim 8, further comprising a text analysis engine.

10. The system of claim 9, wherein the text analysis engine multiplies the assigned value for every word on the list that is also in the text portion of a web page by an associated value, sums together the products, and supplies the sum to a thresholder implementing a sigmoid function.

11. The system of claim further comprising an image analysis engine.

12. The system of claim 11, further comprising a tone filter.

13. The system of claim 11, further comprising a texture filter.

14. A method for inserting an advertisement into retrieved web content, comprising:
retrieving web content;
retrieving an advertisement;
inserting the advertisement into the web content in a computer that is either the client computer that requested the web content or a server connected to the same LAN or WAN as the computer that requested the web content.

15. The method of claim 14, wherein the advertisement comprises html content.

16. The method of claim 14, further comprising the step of checking the web content to determine if it is pornographic before permitting the web content to be displayed to a user.
